(19) United States
(12) Patent Application Publication
(10) Pub. No.: US 2009/0226698 A1
(43) Pub. Date: Sep. 10, 2009

(54) Method for Producing an Alveolar Panel Element Particularly for Coverings, Packagings, Supporting Surfaces, and Alveolar Panel Element Produced Thereby

(76) Inventor: Massimo De Maria, Oggiona Con Santo Stefano (IT)

Correspondence Address: Modiano & Associati, Via Meravigli, 16, Milan, 20123, IT

(21) Appl. No.: 11/922,884

(22) PCT Filed: Jun. 28, 2006
(86) PCT No.: PCT/EP2006/006263

§ 371 Date: Dec. 26, 2007

(30) Foreign Application Priority Data
Jul. 4, 2005 (IT) MI2005A001263

(51) Int. Cl. B32B 7/04; D01D 5/247

(52) U.S. Cl. 428/309.9; 264/210.1

(57) ABSTRACT

A method for producing an alveolar panel element particularly for coverings, packagings and supporting surfaces, comprising the steps of extruding a first layer and a second layer of thermoplastic material, shaping the first and second layers so as to provide, on each layer, a sheet-like element with elements that protrude on at least one face, and coupling the protruding elements of each layer in order to obtain an alveolar panel element.

### TECHNICAL FIELD

The present invention relates to a method for producing an alveolar panel element particularly for coverings, packagings, supporting surfaces, and to the alveolar panel element produced thereby.

### BACKGROUND ART

As is known, panel elements are already commercially available which are obtained by means of an extruded component made of plastic material, which is shaped like cardboard and is substantially constituted by two mutually spaced sheets joined by thin walls, which delimit a plurality of channels.

Such panel element has good rigidity along the longitudinal direction of the channels but is relatively flexible at right angles thereto, since there are no reinforcement elements that act in that direction.

In order to have a panel element that is capable of having substantially equal strength in both directions, layered panel elements are currently used which are constituted generally by a first outer layer and a second outer layer, which are combined with an internal layer having an alveolar configuration of various kinds, so as to obtain an alveolar panel element which, while having adequate lightness, is capable of offering good rigidity.

However, this embodiment suffers various drawbacks, the first of which consists in that it is necessary to join three separate elements and moreover it is not infrequent for the layers to separate from each other, thus interrupting the monolithic configuration and strength of the resulting panel element.

### DISCLOSURE OF THE INVENTION

The aim of the invention is to provide an alveolar panel element particularly for coverings, packagings, supporting surfaces and the like that allows to have optimum strength both in a longitudinal direction and in a transverse direction, being provided in practice as a monolithic element.

Within this aim, an object of the invention is to provide a method that allows to obtain the alveolar panel element starting substantially from a traditional extrusion process, which allows to adjust at will the dimensional features of the panel element that is obtained.

Another object of the present invention is to provide a method which, thanks to its particular characteristics, is capable of giving the greatest assurances of reliability and safety in use.

Another object of the present invention is to provide a method that can be carried out starting from commonly commercially available elements and materials and is further competitive from a merely economical standpoint.

This aim and these and other objects, which will become better apparent hereinafter, are achieved by a method for producing an alveolar panel element particularly for coverings, packagings, supporting surfaces and the like, according to the invention, characterized in that it consists in extruding a first layer and a second layer of thermoplastic material, in shaping said first and second layers so as to provide, on each layer, a sheet-like element with elements that protrude on at least one face, and in coupling one another the protruding elements of each layer in order to obtain an alveolar panel element.

### BRIEF DESCRIPTION OF THE DRAWINGS

Further characteristics and advantages of the present invention will become better apparent from the description of a preferred but not exclusive embodiment of a method for manufacturing an alveolar panel element particularly for coverings, packagings, supporting surfaces and the like, illustrated by way of non-limiting example in the accompanying drawings, wherein:

FIG. 1 is a schematic view of the machine for providing a panel element according to the invention;

FIG. 2 is a view of a detail of the extruded layer that is shaped;

FIG. 3 is a view of the step for cooling the shaped layer;

FIG. 4 is a view of the step for coupling the two layers provided with protruding elements on one face;

FIG. 5 is a schematic perspective view of a layer with honeycomb protruding elements;

FIG. 6 is a schematic perspective view of the alveolar panel element obtained by coupling the two layers;

FIG. 7 is a sectional view, taken along the line VII-VII of FIG. 6;

FIG. 8 is a schematic perspective view of a layer with rhomboidal protruding elements;

FIG. 9 is a view of a layer with protruding elements that delimit cylindrical cavities;

FIG. 10 is a transverse sectional view of a possible different embodiment of the panel element.

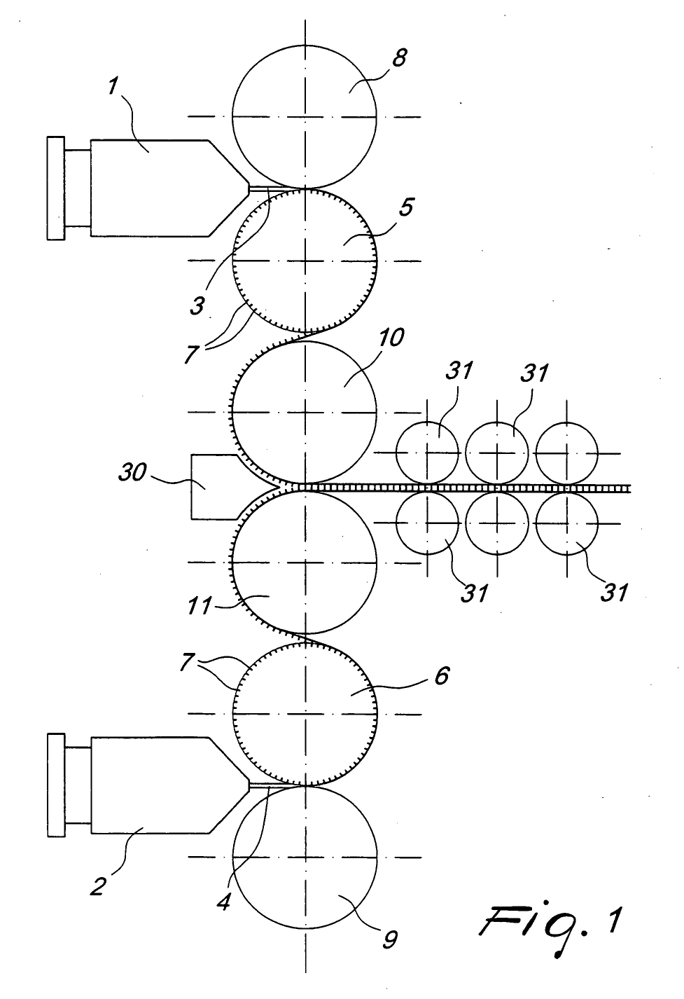

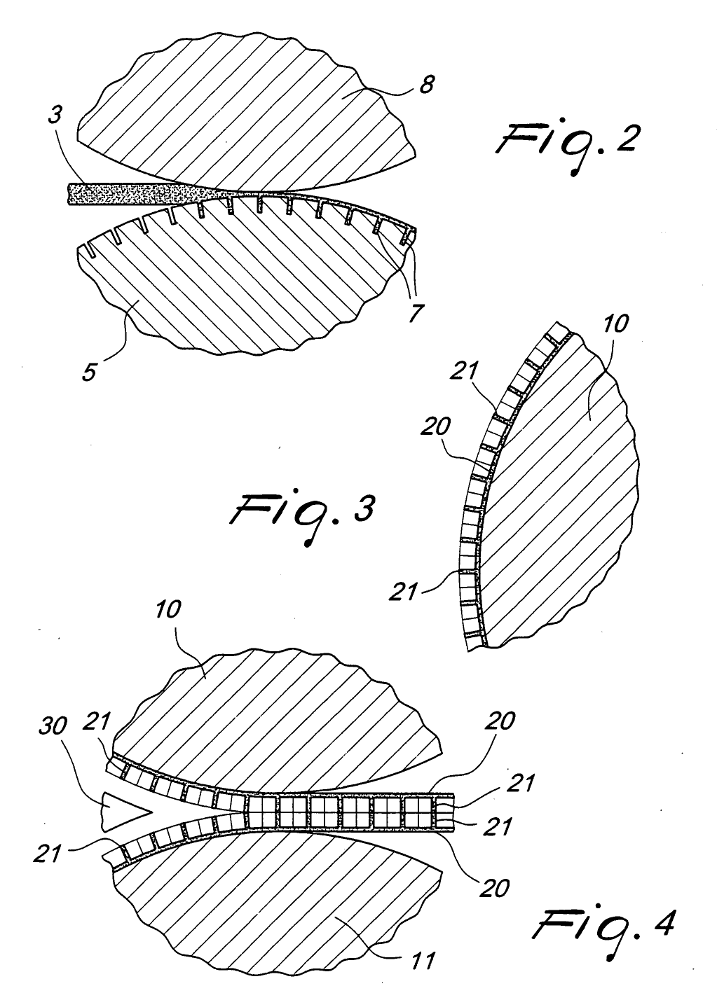

### WAYS OF CARRYING OUT THE INVENTION

With reference to the figures, the method for providing an alveolar panel element particularly for coverings, packagings, supporting surfaces and the like, according to the invention, entails using a first extruder head 1 and a second extruder head 2 to obtain respectively a first layer 3 and a second layer 4 made of thermoplastic material, which can be constituted by high-density polyethylene, polypropylene and the like.

Each extruded layer 3 and 4 is applied to a respective shaping roller 5 and 6, which has on its surface recesses, designated by the reference numeral 7 for both rollers, which match the pattern of the protruding elements to be obtained.

To perform the shaping, there is respectively a first contrast roller 8 and a second contrast roller 9, which in practice shape the extruded layer by introducing it in the cavities provided in the shaping rollers 5 and 6 and, by varying their mutual distance, adjust the thickness of the sheet-like element on which the protruding elements are provided.

As is usual in these shaping processes, the rollers 5 and 6 are kept at a preset temperature so as to be able to extract the shaped layer with coupling onto corresponding finishing rollers, designated by the reference numerals 10 and 11, which in practice engage a face of the shaped layer, on the opposite side with respect to the protruding elements.

The layer is shaped so as to form a sheet-like element, designated by the reference numeral 20, from which protruding elements 21 protrude on at least one face; in a preferred embodiment, such protruding elements form a cavity which is closed perimetrically and open at the face that lies opposite the bottom.

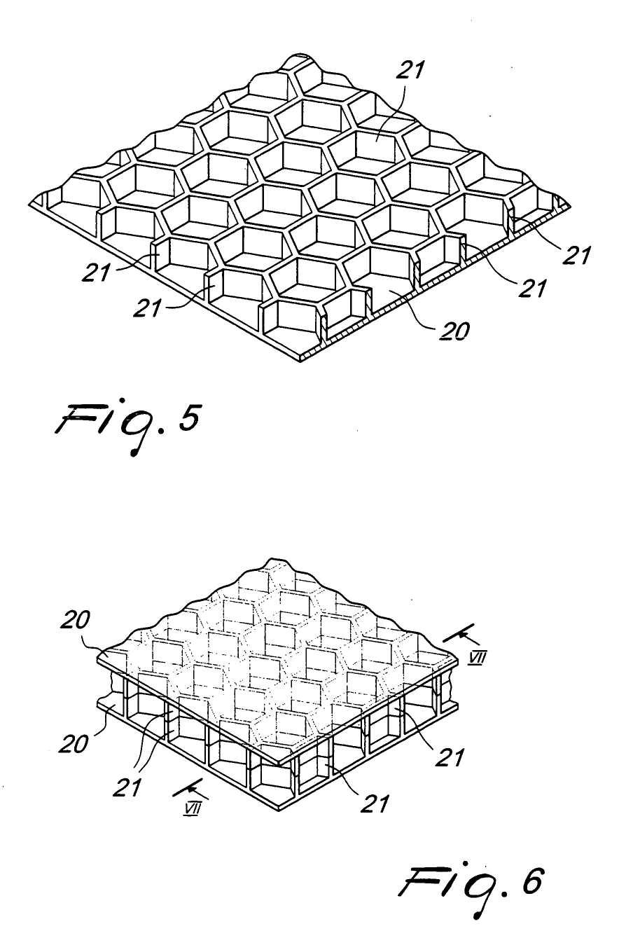

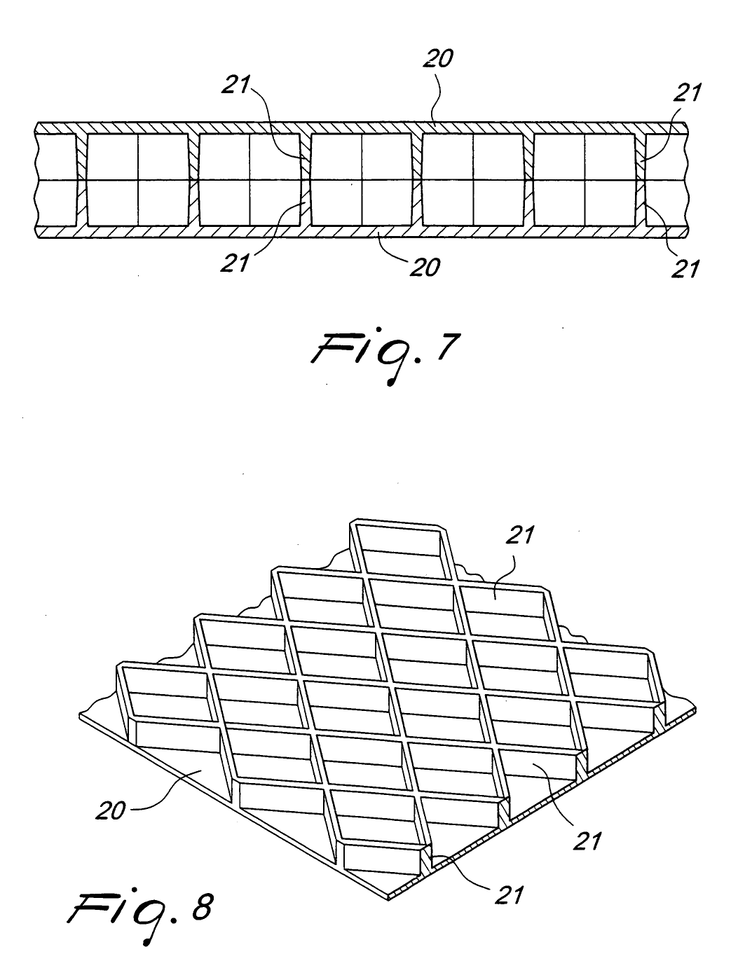

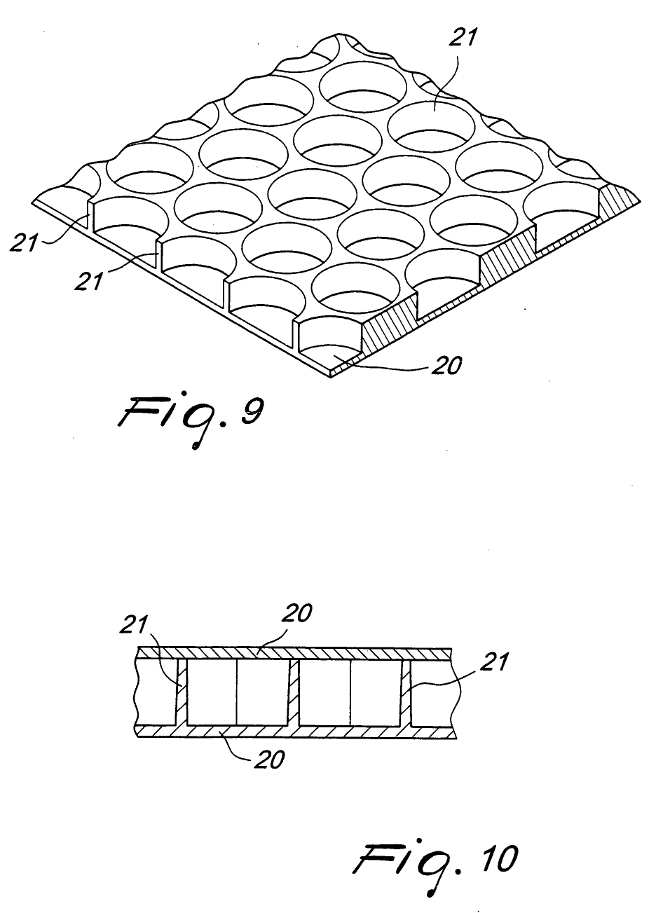

According to what is shown in FIGS. 5 to 7, the cavity has a hexagonal shape, of the honeycomb type; likewise, in FIG. 8 there are elements, again designated by the reference numeral 21, which form rhomboidal or otherwise polygonal cavities formed by straight walls or optionally, as shown in FIG. 9, the protruding elements have variable dimensions and delimit together cylindrical cavities which have a circular base.

In practice, the finishing rollers 10 and 11 engage the smooth face, cooling it, and are mutually opposite so as to provide the coupling of the protruding elements that are in practice joined each other.

According to a preferred but not exclusive embodiment, a heating unit 30, for example a blower, is arranged at the coupling region of the first and second layers and allows to soften the end regions of the elements 21, which advantageously have a frustum-shaped cross-section which is wider on the side of the sheet-like element 20, so as to facilitate the step of extraction from the shaping rollers 5 and 6.

The two layers, again designated by the reference numerals 3 and 4, are arranged in step, and are preferably identical so as to couple correspondingly the protruding elements, which by being melted in localized positions fuse, since they are made of the same thermoplastic material, obtaining a coupling that in practice allows to provide closed cells in order to obtain a monolithic alveolar panel element, in which the two layers are coupled thanks to the presence of a train of coupling and calibration rollers, designated by the reference numeral 31, which keep the two layers mutually positioned after their passage through the finishing rollers 10 and 11, which engage with their smooth faces and allow the coupling of the free ends of the protruding elements.

With the arrangement described above, it is possible to obtain, for the alveolar panel element, a modulus of elasticity that is equal both in a longitudinal direction and in a transverse direction, and it is possible to provide panel elements with a thickness that can range from 3 to 20 mm.

Depending on the different required characteristics, it is possible to change the weight per square meter by changing the thickness of the protruding elements and/or by changing the thickness of the sheet-like element, and therefore it is possible to adapt easily to the various requirements.

Advantageously, the weight per square meter of the resulting panel element ranges preferably from 0.3 to 0.4 kg/m², with the possibility to increase the weight even to 0.6 kg/m².

According to the embodiment shown in FIG. 10, the protruding elements 21 can be provided only on one layer 20, while the other layer 20 is smooth and couples to the protruding elements so as to provide an alveolar panel element.

Moreover, it is possible to apply to the outer surface of the layer 20 an external finishing layer, which can have any shape.

From what has been described above it is therefore evident that the invention achieves the proposed aim and objects, and in particular the fact is stressed that an alveolar element is obtained by coupling just two separate layers which fuse stably together, obtaining a monolithic element.

The invention thus conceived is susceptible of numerous modifications and variations, all of which are within the scope of the appended claims.

Thus, for example, at the time of the coupling between the first layer and the second layer it is possible to provide, if required by particular structural reasons, for the interposition of an intermediate layer, which can be constituted by a net or optionally by a continuous layer which is compatible with the thermoplastic material of the two layers, so as to achieve stable and monolithic coupling.

All the details may further be replaced with other technically equivalent elements.

In practice, the materials used, as well as the contingent shapes and dimensions, may be any according to requirements.

The disclosures in Italian Patent Application No. MI2005A001263 from which this application claims priority are incorporated herein by reference.

What is claimed is:

1-17. (canceled)

18. A method for producing an alveolar panel element particularly for coverings, packagings, supporting surfaces and the like, comprising the steps of extruding a first layer and a second layer of thermoplastic material, shaping said first and second layers so as to provide, on each layer, a sheet-like element with elements that protrude on at least one face, and coupling one another the protruding elements of each layer in order to obtain an alveolar panel element.

19. The method according to claim 18, wherein each one of said extruded layers is positioned on a shaping roller which is provided on its surface with recesses that correspond to the pattern of said protruding elements, contrast rollers being provided for shaping.

20. The method according to claim 19, wherein said protruding elements form cavities which are closed perimetrically and are open at a face that lies opposite a bottom.

21. The method according to claim 20, wherein said cavities have a hexagonal shape.

22. The method according to claim 20, wherein said cavities are rhomboidal.

23. The method according to claim 20, wherein said cavities are substantially polygonal.

24. The method according to claim 20, wherein said cavities have a substantially circular shape.

25. The method according to claim 18, wherein said first and second layers are subjected, after the shaping step, to a step for heating free ends of said protruding elements for mutual coupling with the protruding elements of the layers that are mutually coupled, by localized melting.

26. The method according to claim 18, wherein said protruding elements have a cross-section which is substantially frustum-shaped and is wider on a side of said panel element.

27. The method according to claim 25, wherein a calibration step is performed in order to couple said layers so as to stabilize the mutual fixing of the free ends of said protruding elements.

28. The method according to claim 27, wherein it provides for the insertion of an intermediate layer when said first and second layers are coupled.

29. An alveolar panel element, comprising a first layer and a second layer, at least one of said layers forming, on at least one face, protruding elements in order to provide a monolithic alveolar panel element upon coupling with the other layer.

30. The panel element according to claim 29, further comprising an intermediate layer interposed between said protruding elements.

31. The panel element according to claim 29, further comprising a covering layer applied to the outer face of at least one of said layers.

32. An alveolar panel element, comprising a first layer and a second layer, which form, on at least one face, protruding elements which can be mutually coupled so as to provide a monolithic alveolar panel element.

33. The panel element according to claim 32, wherein said protruding elements form perimetrically closed cavities and said protruding elements can be mutually coupled with the protruding elements of the other layer at their free ends.

34. The panel element according to claim 32, further comprising an intermediate layer interposed between said protruding elements.

35. The panel element according to claim 32, further comprising a covering layer applied to the outer face of at least one of said layers.

36. A panel element, obtained with the method according to claim 18.
